(19) United States
(12) Patent Application Publication
(10) Pub. No.: US 2018/0274151 A1
(43) Pub. Date: Sep. 27, 2018

(54) Washing Machine, Micro-Bubble Generator Thereof, And Method for Supplying Wash Water Including Micro-Bubbles in a Washing Machine

(71) Applicant: Dongbu Daewoo Electronics Corporation, Seoul (KR)

(72) Inventor: Ui Kun HWANG, Incheon (KR)

(21) Appl. No.: 15/919,921

(22) Filed: Mar. 13, 2018

(30) Foreign Application Priority Data
Mar. 23, 2017 (KR) 10-2017-0037134

(51) Int. Cl. D06F 35/00; D06F 17/12; D06F 39/08; B01F 3/04

(52) U.S. Cl. CPC D06F 35/002; D06F 17/12; D06F 35/006; B01F 2215/0077; D06F 39/083; B01F 3/04106; B01F 2003/04858; D06F 39/088

(57) ABSTRACT

A washing machine includes a cabinet; an outer basket in the cabinet and configured to contain wash water; an inner basket in the outer basket and configured to accommodate laundry; a water supply valve unit in the cabinet and connected to an external water supply source to receive wash water; a cabinet cover on an upper side of the cabinet and having an input hole for the laundry; and a micro-bubble generator configured to receive wash water from the water supply valve unit, generate micro-bubbles, and supply the micro-bubbles to a washing space. The micro-bubble generator includes a nozzle unit at or near the input hole and configured to generate micro-bubbles by receive wash water in which gas is dissolved or mixed and discharge wash water having the micro-bubbles therein into the inner basket after the micro-bubbles are generated.

### TECHNICAL FIELD

The disclosure relates to a washing machine, a micro-bubble generator of the washing machine, and a method for supplying micro-bubbles in the washing machine.

### BACKGROUND

A washing machine is a device for separating contaminants from laundry by using wash water and detergent, and may separate contaminants from the laundry by chemical action using a detergent dissolved in the wash water and mechanical action of the wash water and an inner basket.

The detergent is usually put in with wash water and dissolved in the wash water during the washing process to remove the contaminants from the laundry by the chemical action. However, depending on the temperature and amount of the wash water, the amount of the introduced detergent, etc., the detergent may not dissolve in the wash water and may remain in the laundry. When the detergent is not sufficiently dissolved, cleaning action may not be sufficient, and accordingly, contaminants may remain in the laundry. Detergent or foreign matter remaining in the laundry may reduce the user's satisfaction and may cause skin troubles.

Various techniques have been proposed to eliminate the detergent or foreign matter remaining in laundry. For example, a micro-bubble method has been proposed. A micro-bubble refers to a small bubble having a diameter with a few micrometers or a few nanometers, and can be characterized as being dissolved and disappearing completely in water. Specifically, micro-bubbles may be generally understood as a concept collectively encompassing micro bubbles having a diameter of 50 μm or less, micro/nano-bubbles (having diameters of 10 nm or more and less than 1 μm), and nano-bubbles (having diameters of less than 10 nm). Micro-bubbles have high internal pressures, so that if the micro-bubbles burst in the water, they may impact any nearby laundry, thereby effectively separating the detergent or foreign matter remaining in the nearby laundry.

In order to generate the micro-bubbles, a micro-bubble generator is provided in the washing machine. Micro-bubble generators include a separate power device such as a compressor and a pump that may be directly used to generate the bubbles, and a flow characteristic that may be used without the separate power device.

However, since micro-bubble generators using the power device are required to use a high-performance power device to generate micro-bubbles, there are disadvantages in that the structure is complicated, the maintenance cost is high, the noise and vibration are serious, and the production unit cost is increased. In contrast, micro-bubble generators without the power device have advantages in that the structure may be simple, the maintenance cost may be lowered, the noise and vibration may be relatively weak, and the manufacturing cost of the washing machine may be lowered.

However, in the case of a micro-bubble generator which does not use a power device, the space limitation inside the washing machine and the time limitations on the washing process may make it difficult to generate a sufficient amount of micro-bubbles.

Specifically, in order to increase the amount of micro-bubbles, it is preferable to sufficiently dissolve or mix gas in the wash water before the wash water passes through a certain flow path. This may require a space where a large amount of gas is stored, and it may take a long time for the gas to be dissolved or mixed in the wash water. However, since the size of the internal space of the washing machine and/or the time available for dissolving or mixing the gas in the wash water is limited, it is not easy to sufficiently dissolve or mix the gas in the wash water to make a sufficient amount of micro-bubbles.

### SUMMARY

In view of the foregoing, embodiments of the disclosure provide a washing machine, a micro-bubble generator for the washing machine, and a method for supplying wash water including micro-bubbles in the washing machine, capable of increasing the amount of micro-bubbles and improving the washing and rinsing abilities of the washing machine.

### BRIEF DESCRIPTION OF THE DRAWINGS

FIG. 1 is a schematic view showing a washing machine according to an embodiment of the disclosure;

FIG. 2 is a view showing a configuration of the micro-bubble generator in FIG. 1;

FIG. 3 is an exploded perspective view of the dissolving unit in FIG. 2;

FIG. 4 is a cross-sectional view of the dissolving unit in FIG. 2;

FIG. 5 is an exploded perspective view of the nozzle unit in FIG. 2;

FIG. 6 is a cross-sectional view of the nozzle unit in FIG. 2;

FIG. 7 is a perspective view showing the cabinet cover in FIG. 1 viewed from above;

FIG. 8 is an exploded perspective view showing a state in which the nozzle unit is coupled to the cabinet cover of FIG. 7;

FIG. 9 is a cross-sectional view of a nozzle unit in which a vibration-proof rubber gasket or ring and a bolt shown in FIG. 8 are coupled to each other;

FIG. 10 is an exploded perspective view of the drain unit in FIG. 2; and

FIG. 11 is a cross-sectional view of the drain unit in FIG. 2.

### DETAILED DESCRIPTION

Hereinafter, specific embodiments of the present disclosure will be described in detail with reference to the drawings.

In addition, in the description of the present disclosure, the detailed description of known functions and configurations incorporated herein will be omitted if they unnecessarily obscure the features of the subject matter of the present disclosure.

A washing machine is for washing laundry, and various types of washing machines are used, that is, a top loading type washing machine, a front-loading type drum washing machine, and a hybrid type washing machine combining the top loading type and the front-loading type. Typically, such a washing machine includes an inner basket (a drum) where laundry is received, an outer basket where the laundry is accommodated, a motor that drives it, and the like.

In one embodiment, the top loading type washing machine is described as an example, but an idea of the disclosure may be applicable to other types of washing machines.

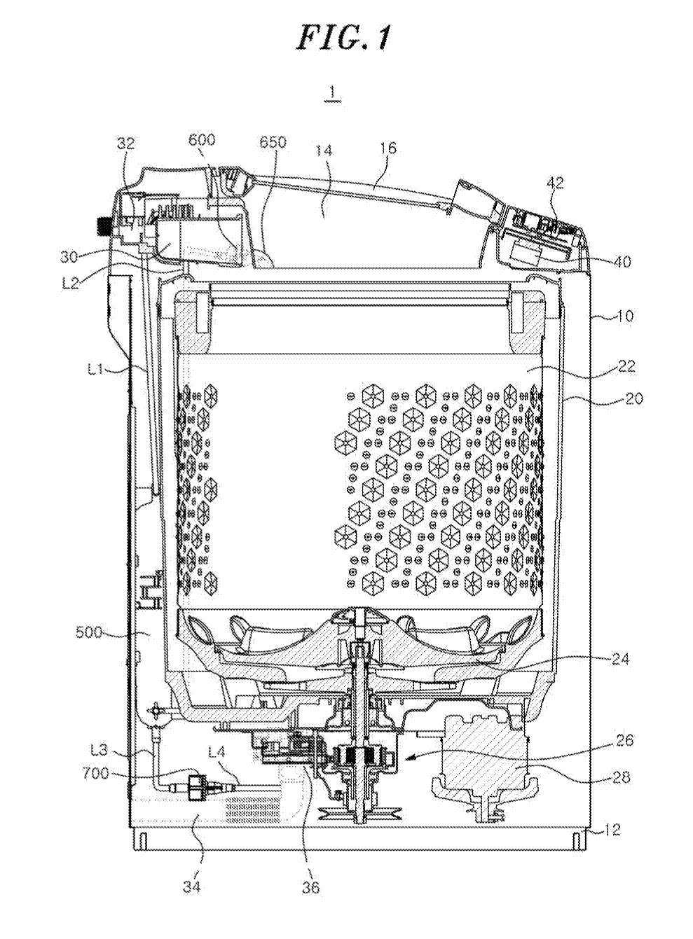

FIG. 1 is a schematic view showing a washing machine according to an embodiment of the disclosure.

Referring to FIG. 1, a washing machine 1 according to an embodiment of the disclosure includes a cabinet 10 forming an outer appearance, a base 12 coupled to a lower portion of the cabinet 10, a cabinet cover 14 coupled to an upper portion of the cabinet 10, and a door 16 which is coupled to the cabinet cover 14 and which may be opened or closed.

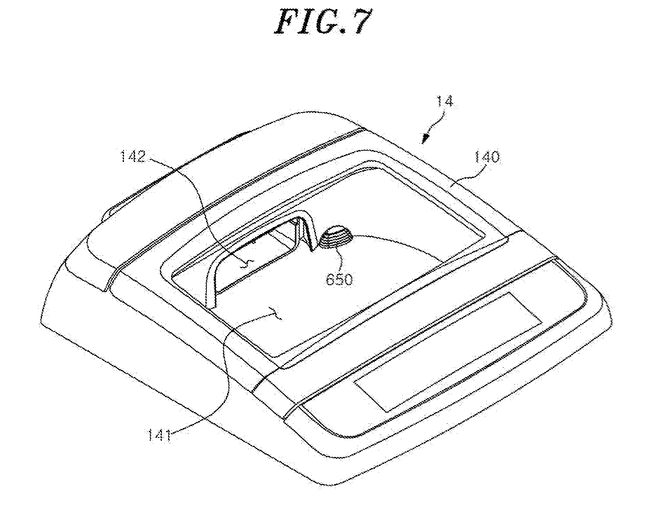

Specifically, the cabinet 10 may have upper and lower surfaces and may be have or form one or more side surfaces of the washing machine 1. A base 12 supporting the washing machine 1 may be provided on the lower side of the cabinet 10, and a cabinet cover 14 may be coupled to the upper side of the cabinet 10. The cabinet cover 14 on the upper side of the cabinet 10 may include an input hole 141 (see FIG. 7) for inputting laundry. In addition, a door 16 is on the cabinet cover 14, and the door 16 may close or open the input hole 141 for loading or unloading the laundry. The user may open or close the door 16 to load the laundry in the washing machine 1 when a washing process is required, or unload the laundry when the washing process is completed, and may shield the laundry by covering the input hole 141 with the door 16 when performing the washing process.

In addition, the washing machine 1 may include an outer basket 20, which is housed in the cabinet 10 and which may contain wash water, and an inner basket 22, which is in the outer basket 20 and which receives the laundry. The outer basket 20 and the inner basket 22 are inside the cabinet 10, and the outer basket 20 and the inner basket 22 have a shape corresponding to each other, wherein the inner basket 22 may have a diameter that is smaller than the diameter of the base 20 by a predetermined length. That is, the inner basket 22 may be spaced apart from the outer basket 20 by a predetermined distance on the inside of the outer basket 20. A plurality of holes for fluid communication with fluid in the outer basket 20 may be in or around the inner basket 22. The outer basket 20 and the inner basket 22 are in fluid communication with each other through the plurality of holes in the inner basket 22, such that the wash water of the inner basket 22 may flow into the outer basket 20. Likewise, the wash water of the outer basket 20 may flow into the inner basket 22. The outer basket 20 and the inner basket 22 may have a cylindrical shape, but are not limited thereto.

The washing machine 1 of the top loading type as in the present embodiment may further include a pulsator 24. The pulsator 24 may be joined to or integrated with the lower portion of the inner basket 22 to form a bottom surface of the inner basket 22. The pulsator 24 is on the bottom of the inner basket 22 and forms a rotating flow and vortex in the wash water in the laundry space. As used herein, the laundry space is a space inside the outer basket 20, and includes an inner space of the inner basket 22. Accordingly, the laundry space refers to a space where the laundry and the wash water may be accommodated. The pulsator 24 is connected to a gear assembly 26 and may be rotated by a rotational force from the motor 28 through the gear assembly 26. A strong vortex may be formed in the radial direction by the rotational force of the pulsator 24, and the washing process may be performed while the wash water and laundry in the inner basket 22 are rotated by the strong vortex. During the washing process, the wash water between the inner basket 22 and the outer basket 20 may rise upwards due to the strong radial vortex in the inner basket 22. Accordingly, the wash water circulates in the washing space including the outer basket 20 and the inner basket 22 for a washing time, and the laundry may be washed while the vortex is present. In some cases, as the pulsator 24 rotates, the inner basket 22 may or may not rotate together with the pulsator 24. For example, when the inner basket 22 and the pulsator 24 are integral with each other, the inner basket 22 may rotate together with the pulsator 24 when the pulsator 24 rotates, and when the pulsator 24 and the inner basket 22 are separate and fastened to each other, only the pulsator 24 rotates to form the vortex.

Meanwhile, in a case where the washing machine 1 is a drum-type washing machine which does not include the pulsator 24, the gear assembly 26 and the motor 28 may be connected directly to the outer basket 20 or the inner basket 22.

Further, the washing machine 1 may include a detergent container 30, a water supply valve unit 32, a main drain hose 34 and a main drain valve 36.

The detergent container 30 may have a drawer shape that moves in a sliding manner in a detergent container receiving portion 142 (see FIG. 7) of the cabinet cover 14. The detergent container 30 may be divided into a space in which detergent is accommodated and a space in which a softening agent is accommodated. The opening and closing of the detergent container 30 may be made toward the inner side of the washing machine 1, and the water supply valve unit 32 may be connected to the outer side of the detergent container 30. (Hereinafter, a direction towards the inner basket 22 may be referred to as an “inner side,” and a direction towards the cabinet 10 forming the outer appearance of the washing machine 1 may be referred to as an “outer side”.) The wash water may be supplied to the detergent container 30 through the water supply valve unit 32 connected to an external water supply source, then to the inner basket 22 through the detergent container 30. Since the wash water is supplied to the inner basket 22 through the detergent container 30, the wash water supplied to the inner basket 22 may contain a detergent or softening agent dissolved or suspended therein.

The water supply valve unit 32 may be on the cabinet cover 14 and may be connected to an external water supply source via an external hose (not shown) to receive the wash water from the external water supply source. The water supply valve unit 32 may be or comprise a four-way valve (not shown). Although not shown in the drawings, the four-way valve may include a hot water supply valve for supplying hot water, a cold water supply valve for supplying cold water, and a micro-bubble water supply valve for supplying cold water to generate micro-bubbles. The hot water supply valve may be in fluid communication with the space in which the detergent is accommodated. In addition, the cold water supply valve may be or comprise a two-way valve, one being in fluid communication with the space in which the detergent is accommodated and the other being in fluid communication with the space in which the softening agent is accommodated. The micro-bubble water supply valve may be connected to a dissolving unit 500 for producing micro-bubbles.

The main drain valve 36 may be at a lower portion of the outer basket 20 and may control whether the wash water in the outer basket 20 is discharged. Specifically, the main drain valve 36 may communicate with the lower portion of the outer basket 20, and the main drain hose 34 may be connected to the main drain valve 36. When the wash water used for washing is discharged to the outside, the main drain valve 36 may be opened to discharge the wash water through the main drain hose 34, and when the wash water is supplied for performing the washing process, the main drain valve 36 may be closed to allow the wash water to be received in the outer basket 20 and the inner basket 22.

In addition, the washing machine 1 may include a control unit 40 and an operation unit 42. The operation unit 42 may include a user interface unit on the cabinet cover 14 and configured to input a predetermined command by the user or output predetermined information to the user. The control unit 40 may control the motor 28, the pulsator 24, the water supply valve unit 32, the operation unit 42, and the like. For example, when the user sets a washing course, a washing time, and the like through the operation unit 42, the control unit 40 may control the motor 28, the pulsator 24, the water supply valve unit 32 or the like to perform the washing process corresponding to the settings.

Meanwhile, the washing machine 1 may include a micro-bubble generator BG that receives the wash water from the water supply valve unit 32, generates the micro-bubbles, and supplies the micro-bubbles to the washing space. The micro-bubble generator BG may include a dissolving unit 500, a nozzle unit 600, and a drain unit 700.

The washing machine 1 may further include a water supply line L1, a supply line L2, a first drain line L3 and a second drain line L4 connecting the micro-bubble generator BG to other components. The water supply line L1 may supply the wash water to the dissolving unit 500, and the supply line L2 may provide the wash water in which gas is dissolved or mixed from the dissolving unit 500 to the nozzle unit 600. In addition, the first drain line L3 may provide remaining wash water from the dissolving unit 500 to the drain unit 700, and the second drain line L4 may provide the wash water from the drain unit 700 to the main drain hose 34.

The dissolving unit 500 may dissolve or mix the gas in the wash water from the water supply valve unit 32. In this embodiment, the gas is exemplified by air in the dissolving unit 500, but the gas may be provided from a predetermined gas providing means or mechanism connected to the dissolving unit 500 or provided along with the dissolving unit 500.

The dissolving unit 500 may receive the wash water through the water supply line L1 connected to the water supply valve unit 32 and may generate bubbles in the wash water using the water supply pressure of wash water from the water supply line L1 without using a power unit. In other words, the gas in the dissolving unit 500 may be dissolved or mixed in the wash water supplied into the dissolving unit 500, thereby generating bubbles in the wash water.

The nozzle unit 600 may generate the micro-bubbles from water and gas in the dissolving unit 500 by supplying the wash water with gas through the supply line L2. Specifically, the nozzle unit 600 may generate the micro-bubbles by splitting the bubbles generated as the gas dissolves, mixes or disperses in the wash water in the dissolving unit 500. This nozzle unit 600 may be connected at or near the input hole 141, and the wash water with the micro-bubbles therein may be drawn directly into the inner basket 22 immediately after the micro-bubbles are formed. The micro-bubbles in the nozzle unit 600 gradually disappear over time or when they are moved along a predetermined flow path. As in the present embodiment, as soon as the micro-bubbles are generated in the nozzle unit 600, the micro-bubbles are immediately discharged into the inner basket 22, and the amount of micro-bubble extinction may be minimized and the effect of micro-bubble-containing wash water may be improved.

The drain unit 700 may discharge the wash water remaining in the dissolving unit 500 after the supply of the wash water including the micro-bubbles through the dissolving unit 500 and the nozzle unit 600 is completed. Specifically, the drain unit 700 may be connected to the dissolving unit 500 through the first drain line L3 and may be connected to the main drain hose 34 through the second drain line L4. In this case, the drain unit 700 may discharge the wash water remaining in the dissolving unit 500 to the main drain hose 34.

Hereinafter, a specific configuration of a micro-bubble generator BG according to an embodiment of the disclosure will be described with reference to the drawings.

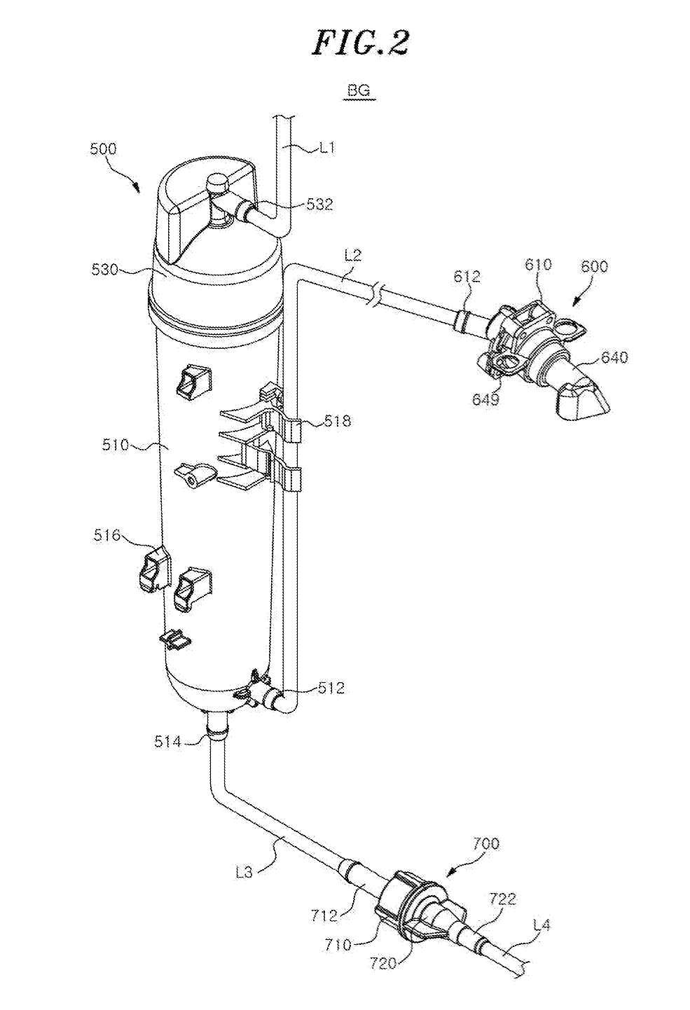

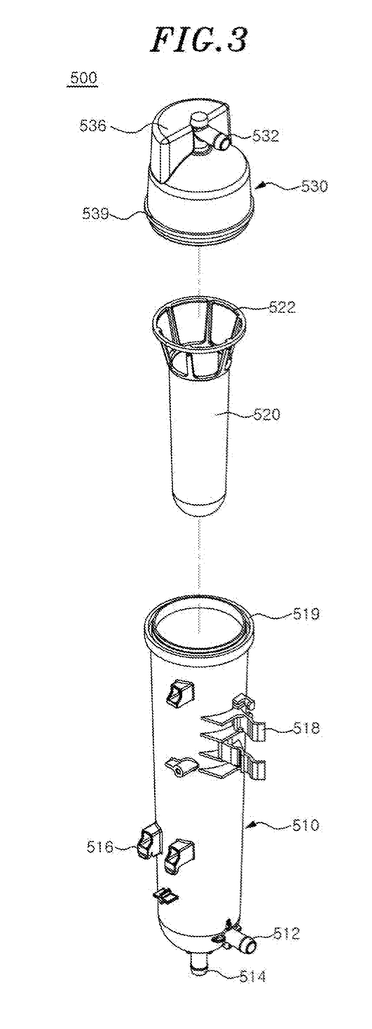

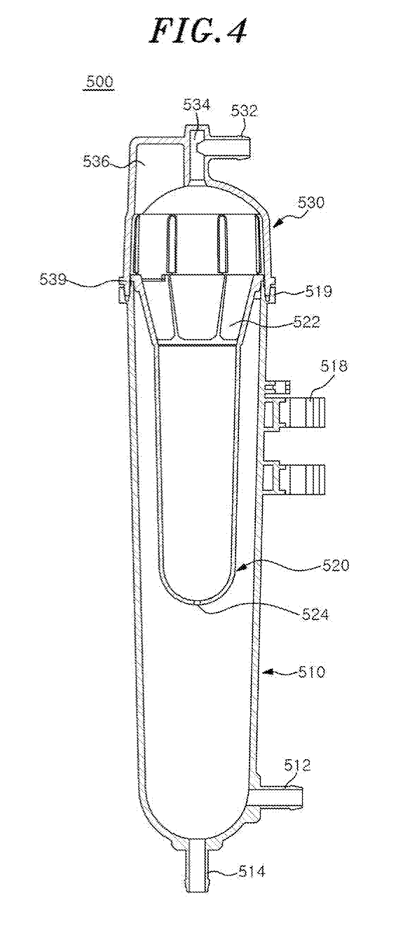

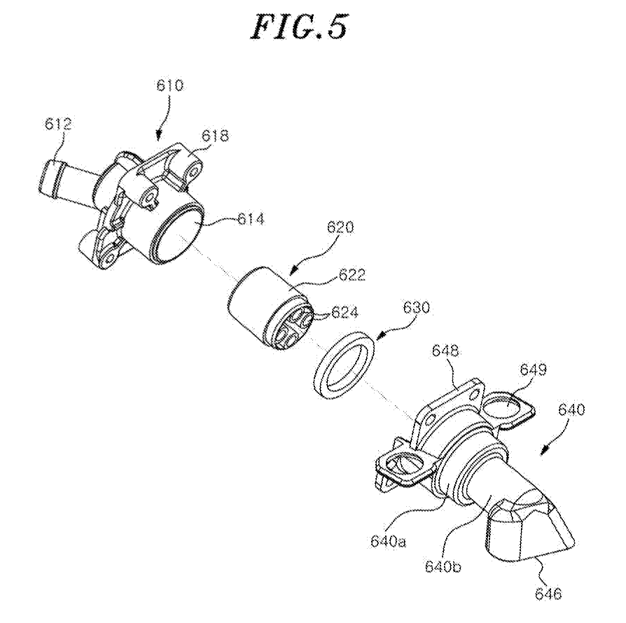

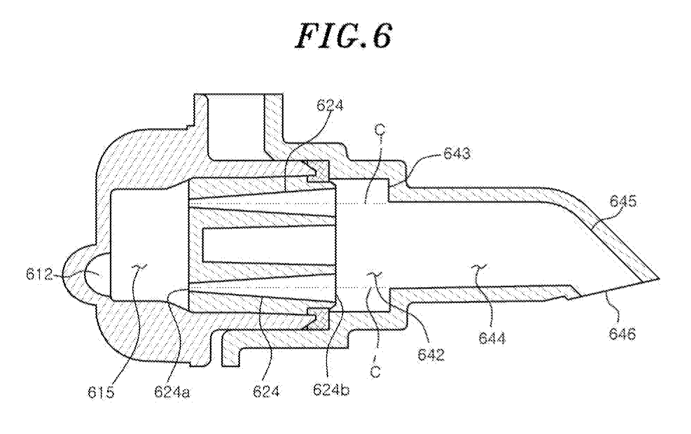

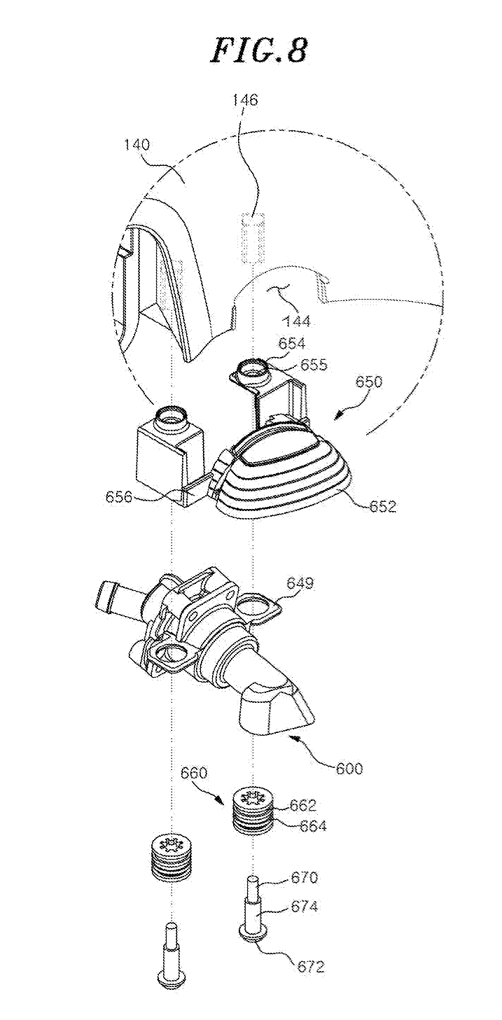

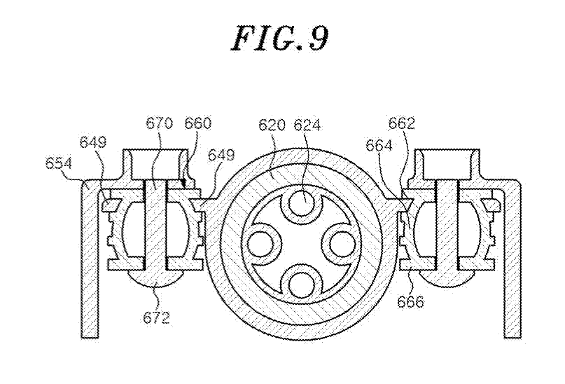

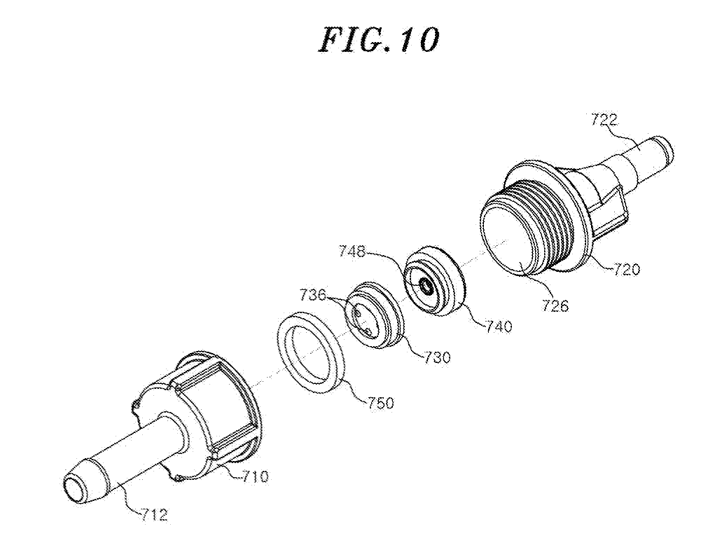

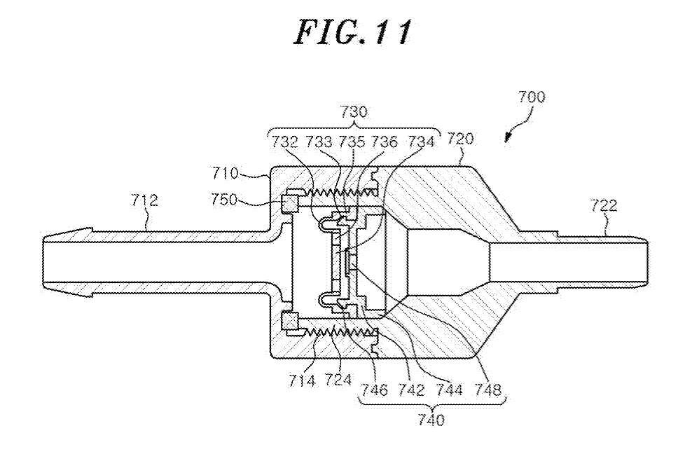

FIG. 2 is a view showing a configuration of the micro-bubble generator in FIG. 1, FIG. 3 is an exploded perspective view of the dissolving unit in FIG. 2, FIG. 4 is a cross-sectional view of the dissolving unit in FIG. 2, FIG. 5 is an exploded perspective view of the nozzle unit in FIG. 2, FIG. 6 is a cross-sectional view of the nozzle unit in FIG. 2, FIG. 7 is a perspective view showing a cabinet cover in FIG. 1 viewed from above, FIG. 8 is an exploded perspective view showing a state in which the nozzle unit is coupled to the cabinet cover in FIG. 7, FIG. 9 is a cross-sectional view of a nozzle unit in which a vibration proof rubber gasket or ring and a bolt according to FIG. 8 are coupled to each other, FIG. 10 is an exploded perspective view of the drain unit in FIG. 2, and FIG. 11 is a cross-sectional view of the drain unit in FIG. 2.

Referring to FIGS. 2 and 11, the micro-bubble generator BG may include a dissolving unit 500, a nozzle unit 600, and a drain unit 700, as described above.

First, the dissolving unit 500 may receive the wash water and dissolve or mix the gas in the dissolving unit 500 in the wash water. The dissolving unit 500 may be below the cabinet 10 and may be between the cabinet 10 and the outer basket 20, such that the dissolving unit 500 may be fixed to the inner side wall of the cabinet 10 and spaced apart from the outer basket 20, where the vibration is largely generated. In addition, the dissolving unit 500 may be oriented in the upper and/or lower direction(s) so that it may be between the narrow outer basket 20 and the cabinet 10. Hereinafter, the “upper and/or lower direction(s)” may mean the direction of gravity with reference to FIG. 1, and may be referred to as a vertical direction. Furthermore, the left and right direction with reference to FIG. 1 may be referred to as a horizontal direction or a direction parallel to the paper surface.

Further, dissolving unit 500 may be on a lower side of the water supply valve unit 32. Specifically, the water supply valve unit 32 may be on the upper side of the dissolving unit 500, and the direction from the water supply valve unit 32 to the dissolving unit 500 is in the direction of gravity. Accordingly, the wash water supplied from the water supply valve unit 32 to the dissolving unit 500 flows along the gravity direction, so that the supply of wash water may be performed more smoothly.

Referring now to FIGS. 2 to 4, the dissolving unit 500 may include an outer tube 510, an inner tube 520 in the outer tube 510, and a cap 530 coupled to the upper portion of the outer tube 510.

First, the outer tube 510 may have a tubular shape with an open upper end to receive the gas and wash water and to provide a dissolution space in which the gas mixes or dissolves in the wash water. The term “dissolution space” refers to the space in which the wash water and the gas meet within the outer tube 510 to dissolve or mix the gas. Such an outer tube 510 may include a nozzle portion connection unit 512, a drain unit connection unit 514, a cabinet fixing unit 516, a supply line fixing unit 518 and a cap fixing unit 519.

The nozzle portion connection unit 512 may connect the supply line L2 and supply the wash water in which the gas is dissolved or mixed to the nozzle unit 600, and may be on the outer circumferential surface of the outer tube 510. In particular, it may be at the lower portion of the outer circumference of the outer tube 510.

The drain unit connection unit 514 may direct the wash water remaining in the outer tube 510 to the drain unit 700. The first drain line L3 may be connected to the drain unit connection unit 514 such that the wash water remaining in the outer tube 510 is discharged to the drain unit 700. In particular, the drain unit connection unit 514 may be in the lower portion of the outer tube 510.

Meanwhile, the nozzle portion connection unit 512 and the drain unit connection unit 514 may be oriented in different directions. For example, the nozzle portion connection unit 512 may protrude laterally along an orientation of the nozzle unit 600 from a lower portion of the outer tube 510 so as to be easily connected to the nozzle unit 600 on the upper side of the dissolving unit 500. The drain unit connection unit 514 may protrude from a lower portion of the outer tube 510 to the lower side thereof in order to easily connect the drain unit 700 on the lower side of the dissolving unit 500. In particular, the drain unit connection unit 514 may be at the lowermost portion of the outer tube 510 to drain the wash water remaining in the outer tube 510, and it may extend in a lower side direction corresponding to the direction in which the wash water flows by gravity. However, the nozzle portion connection unit 512 and the drain unit connection unit 514 are not limited to the above-described positions and directions.

The cabinet fixing unit 516 may be or comprise one or more hanging protrusions or hooks extending toward an inner surface of a side wall of the cabinet 10 for stably fixing the dissolving unit 500 to the cabinet 10, and may be on the outer circumferential surface of the outer tube 510.

The supply line fixing unit 518 is configured to stably fix the supply line L2 that guides the wash water in which the gas is dissolved or mixed to the discharging position. Specifically, the supply line fixing unit 518 may fix the supply line L2 that supplies the wash water with dissolved gas or gas mixed therein to the nozzle unit 600. For this purpose, the supply line fixing unit 518 may be at a position along or adjacent to the outer circumferential surface of the outer tube 510.

The cap fixing unit 519 may be at the upper end of the outer tube 510 to fix the outer tube 510 and the cap 530 together. The cap fixing unit 519 may be or comprise a rib extending to the outer side along the outer circumferential surface of the upper end of the outer tube 510.

The inner tube 520 may be inserted into the dissolution space of the dissolving unit 500. Specifically, the inner tube 520 may be inserted into the inner side of the outer tube 510, and at least a portion thereof may be spaced from the inner circumferential surface of the outer tube 510. For example, the inner tube 520 may be formed such that the side and lower ends thereof are spaced from the inner side surface of the outer tube 510. However, the embodiment is not limited to a configuration in which the side surface and the lower end of the inner tube 520 are spaced apart from the inner side surface of the outer tube 510. Instead, one side surface of the inner tube 520 may be on the inner side surface of the outer tube 510, and another side surface and the lower end portion may be spaced apart from the inner side surface of the outer tube 510. Again, as described above, the dissolution space means a space in which the wash water meets and mixes or dissolves the gas meet inside the outer tube 510, and the inner tube 520 in the outer tube 510 further includes an internal space.

In particular, the volume of the inner space of the inner tube 520 may be less than one-third of the volume of the inner space of the outer tube 510. For example, the lower end of the inner tube 520 may be more than ⅓ of the way along the length of the outer tube 510 from the lower end of the outer tube 510. This may increase the amount of gas dissolved or mixed in the wash water in the dissolving unit 500. Specifically, the gas in the dissolution space may be dissolved or mixed in the wash water supplied to the inner tube 520 through the water supply line connection unit 532 to generate micro-bubbles. The dissolution of the gas substantially occurs owing to the movement of overflowing wash water into the space between the inner tube 520 and the outer tube 510. Accordingly, as the volume difference between the outer tube 510 and the inner tube 520 increases, the space for storing and dissolving the gas in the outer tube 510 may increase. However, the volume of the inner space of the inner tube 520 may not be smaller than ½ of the volume of the inner space of the outer tube 510. If the volume in the inner tube 520 is less than one-half of the volume in the outer tube 510, the amount of wash water to dissolve or mix the gas may decrease, and the amount of bubble generation may decrease.

Such an inner tube 520 may include an overflow portion 522 and a residual water discharge hole 524. The overflow portion 522 may include a plurality of overflow holes along the circumference of the inner tube 520 so that the wash water flowing into the inner space of the inner tube 520 may overflow at the upper end of the inner tube 520. For example, the overflow portion 522 may include a plurality of ribs extending radially at the upper end of the inner tube 520, and the space between the ribs may form or become an overflow hole. In this configuration, the upper end of the overflow portion 522 may be seated on the upper end of the outer tube 510, so that the inner tube 520 may be fixed to the outer tube 510.

The wash water supplied through the water supply line connection unit 532 may be supplied to the inner tube 520. When the wash water overflows from the inner tube 520, the wash water may fall into the dissolution space between the inner tube 520 and the outer tube 510 through the overflow portion 522. Consequently, the gas and wash water may be dissolved or mixed in the dissolution space to generate bubbles.

The residual water discharge hole 524 is a hole configured to drain the wash water in the inner tube 520 to the drain unit 700 after the wash water containing bubbles is supplied to the nozzle unit 600. The residual water discharge hole 524 may be at the lowermost end of the inner tube 520, and the diameter of the residual water discharge hole 524 may be smaller than the diameter of the upper end opening of the inner tube 520. Accordingly, the supply amount of the wash water flowing into the inner tube 520 may be larger than the drain amount, and the wash water may overflow in the inner tube 520.

The residual water discharge hole 524 may be located directly above the drain unit connection unit 514 connecting the wash water remaining in the outer tube 510 to the drain unit 700. Therefore, in the process of discharging the remaining wash water, the wash water remaining in the inner tube 520 may drain through the residual water discharge hole 524 at the lowermost end of the inner tube 520, such that the wash water may be discharged directly to the drain unit connection unit 514. As a result, the wash water remaining in the inner tube 520 may be prevented from remaining in the outer tube 510 in the discharge process once again and may drop into the drain unit connection unit 514 and in turn be discharged immediately.

The cap 530 may be fastened to the upper portion of the outer tube 510 to shield or close the inner and outer tubes 520 and 510. As the cap 530 and the outer tube 510 are fastened, the movement of the gas is blocked so that the gas may be stored in the dissolution space of the dissolving unit 500, and thus, the gas may be stored in the dissolving unit 500.

The cap 530 may further include a water supply direction switching portion 534, an air pocket portion 536, and an outer tube fixing unit 539, as well as the water supply line connection unit 532 described above.

Specifically, the cap 530, which includes the water supply line connection unit 532 and the water supply direction switching portion 534, is coupled to the upper end of the outer tube 510 to shield or close the outer tube 510. The wash water is then supplied from the water supply valve unit 32, and the water supply direction switching portion 534 switches the direction of the wash water introduced through the water supply line connection unit 532 to the direction of the inner tube 520.

The water supply line connection unit 532 may be connected to the water supply line L1 to supply the wash water from the water supply valve unit 32 into the dissolving unit 500.

The water supply line connection unit 532 may extend horizontally from the cap 530 to allow wash water to be introduced horizontally into the cap 530. Specifically, the wash water supplied vertically from the water supply valve unit 32 on the upper side of the dissolving unit 500 may be supplied in a horizontal direction to the water supply line connection unit 532 by switching the direction at least once. Thus, the wash water may enter the water supply line connection unit 532 in the horizontal direction of the cap 530 and then be switched to be discharged in the vertical direction to the inner space of the inner tube 520.

The water supply direction switching portion 534 may communicate with the discharging side or end of the water supply line connection unit 532, and is oriented in the vertical direction at the end of the horizontally-oriented water supply line connection unit 532. Thus, the supply direction switching portion 534 may switch the direction of the wash water from the water supply line connection unit 532 towards the inner tube 520.

The water supply direction switching portion 534 may be at a position corresponding to the center of the inner tube 520, such that the supplied wash water may be discharged to the inner tube 520.

For example, the water supply line connection unit 532 and the water supply direction switching portion 534 may be at an angle of 90 degrees or in an ‘L’ shape. This ‘L’ shape can prevent the wash water from the water supply line L1 from being directly injected into the inner tube 520. The wash water may be uniformly supplied by passing through the ‘L’ shape. On the other hand, when the water supply line connection unit has an ‘I’ shape, the wash water is directly injected from the water supply line L1. When being supplied by direct injection, the water supply is discharged relatively less uniformly. As a result, the overflow of the wash water in the inner tube 520 may occur irregularly, and the dissolution of the gas may not be performed smoothly. However, in accordance with the present embodiment, the wash water spreads out relatively uniformly after colliding with the side wall of the water supply direction switching portion 534 and is then discharged into the inner tube, and the wash water may be relatively uniformly supplied to the inner tube 520. Accordingly, it is possible to smoothly perform the dissolving action of the gas by the overflowing wash water.

Moreover, the water supply line connection unit 532 may be connected to an intermediate point of the water supply direction switching portion 534 along the vertical direction. Accordingly, the wash water supplied from the horizontal direction may enter the water supply direction switching portion 534 oriented in the vertical direction, may hit the inner wall of the water supply direction switching portion 534, and may be spread out along the vertical direction of the water supply direction switching portion 534. Specifically, the wash water may be not directly injected into the inner tube 520 by changing from the horizontal direction to the vertical direction, but may be spread in the vertical direction by colliding against the inner wall of the water supply direction switching portion 534. Accordingly, the flow of the wash water may be made more uniform. Since the wash water is more uniformly supplied to the inner tube 520, the gas in the dissolution space may be more uniformly supplied to the wash water, and the bubbles may be more uniformly formed.

Therefore, the dissolving unit 500 may input the wash water flowing from the water supply valve unit 32 in the horizontal direction by changing the flow of the wash water to the vertical direction, and it is possible to prevent directly injection of water from the water supply valve unit 32 into the dissolving unit 500.

The air pocket portion 536 may be on an opposite side of the water supply line connection unit 532 with respect to the water supply direction switching portion 534, and may communicate with the inner space of the dissolving unit 500 to provide a space to accommodate or store the gas.

Specifically, the air pocket portion 536 may be formed by extending the outer tube 510 to a height at which the water supply direction switching portion 534 extends from the upper portion of the cap 530, to create a space for storing the gas. The air pocket portion 536 may increase the volume of gas stored in the dissolving unit 500, and thus the amount of dissolved or mixed gas may increase.

The outer tube fixing unit 539 may combine and/or fix the cap 530 to the outer tube 510. The outer tube fixing unit 539 may extend to the outer side along the outer circumferential surface of the lower end of the cap 530 and may be or comprise a rib that fits in or to the cap fixing unit 519.

Therefore, in order to fix the outer tube 510 and the cap 530 to each other, the outer tube fixing unit 519 of the outer tube 510 may fit with the outer tube fixing unit 539 of the cap 530. The outer tube 510 and the cap 530 may be sealed while the cap fixing unit 519 and the outer tube fixing unit 539 are fastened. However, the cap fixing unit 519 and the outer tube fixing unit 539 are not limited to a shape of the rib, but may be or comprise a flange or the like.

Next, the nozzle unit 600 may generate micro-bubbles by receiving the wash water in which the gas is dissolved or mixed from the dissolving unit 500. Specifically, the nozzle unit 600 may split the bubbles in the wash water supplied from the dissolving unit 500 into micro-bubbles, or increase the amount of the bubbles to be discharged to the inner basket 22.

Here, referring to FIGS. 2, 5 and 6, the nozzle unit 600 may include a body portion 610 connected to the dissolving unit 500, a bubble generating portion 620 configured to generate micro-bubbles, a gasket 630, and a nozzle portion 640 configured to discharge wash water containing micro-bubbles into the inner basket 22.

The body portion 610 may include a dissolving unit connection unit 612, and the dissolving unit connection unit 612 may be connected to the supply line L2 to receive wash water containing bubbles (dissolved or mixed gas) therein from the dissolving unit 500.

The body portion 610 is supplied with the wash water in which gas is dissolved or mixed, and the wash water may be pressurized in the body portion 610. This body portion 610 may include a dissolving unit connection unit 612, a bubble generating portion accommodating unit 614, a pressing space 615, and one or more nozzle portion connection units 618.

The dissolving unit connection unit 612 may be connected to the supply line L2 to supply the wash water in which the gas is dissolved or mixed from the dissolving unit 500 into the nozzle unit 600.

The bubble generating portion accommodating unit 614 may be connected to the pressing space 615 to accommodate the bubble generating portion 620. The bubble generating portion accommodating unit 614 may communicate with the dissolving unit connection unit 612 and may extend and/or protrude toward the nozzle portion 640. The bubble generating portion accommodating unit 614 may be widened and/or extended, and may have a diameter larger than the dissolving unit connection unit 612. Specifically, the bubble generating portion accommodating unit 614 may correspond to the size, shape, and cross-sectional area of the bubble generating portion 620 so that the bubble generating portion 620 may be inserted therein. However, the bubble generating portion accommodating unit 614 may be longer than the bubble generating portion 620 so that the pressing space 615 may be between the dissolving unit connection unit 612 and the bubble generating portion 620 after the bubble generating portion 620 is inserted in the bubble generating portion accommodating unit 614.

The bubble generating portion accommodating unit 614 may have a step a predetermined distance along the length of the bubble generating portion accommodating unit 614 in order to form the pressing space 615 at the end connected to the dissolving unit connection unit 612 so that it may have a length corresponding to the predetermined distance. By placing or hanging the bubble generating portion 620 at this step, the bubble generating portion 620 may be spaced the predetermined distance from the dissolving unit connection unit 612 when it is inserted into the bubble generating portion accommodating unit 614. As such, it may be understood that the pressing space 615 is the space between the end of the dissolving unit connection unit 612 and the bubble generating portion 620.

The dissolving unit connection unit 612 may be connected to one end of the pressing space 615, so the wash water containing bubbles may be introduced into the pressing space 615. The pressing space 615 may be supplied with the wash water in which the gas is dissolved or mixed from the dissolving unit 500, and the wash water may be pressurized in the pressing space 615. Specifically, the wash water in which the gas is dissolved or mixed may be introduced into the pressing space 615 having a cross-sectional area wider than the supply line L2 through the supply line L2 having a narrow flow path, and thus the wash water in which the gas is dissolved or mixed may be pressurized before passing through the bubble generating portion 620 having a cross-sectional area which is smaller than the sectional area of the pressing space 615. The higher the pressure is, the more bubbles are generated in the wash water. Therefore, the pressure of the bubble-containing wash water in the pressing space 615 may increase, and such pressurized wash water is supplied to the decomposition unit 624.

The nozzle portion connection unit(s) 618 may be around the bubble generating portion accommodating unit 614, and may be connected to the body connection unit 648 of the nozzle portion 640 to fix the body portion 610 and the nozzle portion 640. The nozzle portion connection unit(s) 618 may fasten the body portion 610 to the nozzle portion 640, and the nozzle portion connection unit(s) 618 may extend from opposite sides of the upper portion and opposite sides of the lower portion of the outer peripheral surface of the bubble generating portion accommodating unit 614. However, two nozzle connection units 618 on opposite sides of the upper portion of the bubble generating portion accommodating unit 614 may extend in the direction of the nozzle portion 640, and two nozzle connection units 618 on opposite sides of the lower portion of the bubble generating portion accommodating unit 614 may extend toward the dissolving unit connection unit 612. This is because the lower portion of the body connection unit 648 extends toward the nozzle connection unit 618 when the nozzle portion connection units 618 is fastened to the body connection unit 648 of the nozzle portion 640, as will be described later. The nozzle portion connection unit(s) 618 may be formed such that the upper nozzle portion connection unit(s) 618 protrude toward the body connection unit 648 and the lower nozzle portion connection unit(s) 618 protrude toward the dissolving unit connection unit 612 to correspond to the body connection unit 648. Each nozzle portion connection unit 618 may include a hole through which a fastening member may penetrate or be inserted. A total of four nozzle portion connection units 618 may form a rectangle or square in which they are at vertexes of the rectangle or square, along the outer peripheral surface of the bubble generating portion accommodating unit 614.

The bubble generating portion 620 is inserted into the bubble generating portion accommodating unit 614 at one side of the pressing space 615. The bubble generating portion 620 may include a housing 622 in the body portion 610 and a plurality of decomposition units 624 on the inside along the periphery of the housing 622 at predetermined intervals. In one embodiment, it is to be understood that four decomposition units 624 are in the housing 622, but the disclosure is not limited to four, and may include one or more decomposition units 624.

The decomposition unit 624 may be a tube whose diameter widens along the direction of the fluid flow from the pressing space 615, indicating the flow path in the housing 622. A plurality of decomposition units 624 may be in the housing 622, the decomposition unit 624 may communicate with the pressing space 615, and the wash water introduced into the decomposition unit 624 from the pressing space 615 may pass through the decomposition unit 624 to generate micro-bubbles. In this regard, the opening through which the wash water is introduced into the decomposition unit 624 is referred to as an inlet 624a of the decomposition unit 624, and the opening through which the wash water is discharged from the decomposition unit 624 is referred to as an outlet 624b. The centers of the inlet 624a and the outlet 624b may be linear or on the same line, and the inlet 624a may have a smaller cross-sectional area than the outlet 624b. Thus, the decomposition unit 624 may have a tapered cross-sectional shape expanding from the inlet 624a to the outlet 624b.

The wash water in which the gas is dissolved or mixed may contain relatively large bubbles, and the wash water may be introduced into the inlet 624a of the decomposition unit 624 from the pressing space 615 and discharged to the outlet 624b. The diameter of the inlet 624a communicating with the pressing space 615 may be abruptly or significantly less than the diameter of the pressing space 615, and at the same time, the wash water flows into the inlet 624a from the pressing space 615 at an increased flow rate. After that, the wash water may pass through the gradually expanding decomposition unit 624, where the flow rate of the wash water decreases and the pressure rises. As a result, the bubbles in the wash water the pressing space 615 may be split in the decomposition unit 624 to generate micro-bubbles or new bubbles in the wash water.

A gasket 630 may be around the outlet side of the decomposition unit 624 of bubble generating portion 620. The gasket 630 may press at the end of the body portion 610 while surrounding the bubble generating portion 620 at the inside of the nozzle portion 640 when the bubble generating portion 620 is in the nozzle portion 640. Accordingly, the gasket 630 may be pressurized and fixed by the body portion 610 and the nozzle portion 640, thereby preventing leakage of micro-bubbles and/or the micro-bubble-containing wash water. The gasket 630 may be or comprise an O-ring, but is not limited thereto.

The nozzle portion 640 may be coupled to the body portion 610 so that the bubble generating portion 620 may be accommodated and fixed in place in the body portion 610, and may serve to discharge the wash water containing micro-bubbles into the inner basket 22. The nozzle portion 640 may include a first part 640a forming a first mixing space 642 and a second part 640b connected to the first part 640a, configured to discharge the wash water containing micro-bubbles toward an upper portion of the inner basket 22. The first part 640a and the second part 640b may have blocking parts 643 and 645 which block at least a portion of the flow of wash water from the decomposition units 624 so as not to directly inject the wash water into the inner basket 22, and may include micro-bubble mixing portions 642 and 644 configured to (further) mix the micro-bubbles generated in the decomposition unit 624 with the washing water that has been discharged from the decomposition unit 624 and slow down the flow of the wash water.

Specifically, the first part 640a may include (i) a first mixing space 642 communicating with the dissolving unit 624 and having the same cross-sectional area as the cross-sectional area of the housing 622 and (ii) a first blocking surface 643 that alters the flow of the wash water. Similarly, the second part 640b may include (i) a second mixing space 644 connected to the first mixing space 642 and having a smaller cross-sectional area than the first mixing space 642 and (ii) a second blocking surface 645 that alters the flow of the wash water flowing along the second mixing space 644.

The first mixing space 642 and the second mixing space 644 may increase the amount of the micro-bubble generation by preventing direct injection while maximizing the flow path.

The first mixing space 642 may have a diameter corresponding to the diameter of the bubble generating portion 620 and a cylindrical shape corresponding to the external shape of the bubble generating portion 620. The first mixing space 642 is a space where the wash water having the micro-bubbles from the decomposition unit 624 is mixed with the wash water that has been previously discharged from the decomposition unit 624 and whose flow rate has slowed down. Specifically, after passing through the decomposition unit 624, the wash water with a slow flow rate may be discharged to the first mixing space 642, and some of the wash water with the slow flow rate may stay in the first mixing space 642. In this case, the wash water continuously injected from the decomposition unit 624 and the wash water staying in the first mixing space 642 may collide and mix, the bubbles in the wash water may be further split, and the micro-bubbles may be more uniformly distributed in the wash water.

The second mixing space 644 allows the wash water discharged from the first mixing space 642 to stay for a certain period of time. At this time, additional micro-bubbles may be generated while the wash water staying in the second mixing space 644 may collide with the wash water that is rapidly discharging from the first mixing space 642.

In the embodiment, the second mixing space 644 may have a smaller diameter than the first mixing space 642, and the first mixing space 642 and the second mixing space 644 may have a step at an interface between them. In this case, one side of the step leading from the first mixing space 642 to the second mixing space 644 may be the first blocking surface 643. The step may have an edge at a height corresponding to the center line ‘C’ connecting the center of the inlet 624a of the decomposition unit 624 and the center of the outlet 624b.

The first blocking surface 643 may extend from the side of the first mixing space 642 and may be parallel to the outlet 624b side of the decomposition unit 624 or be inclined so as to protrude or extend toward the decomposition unit 624. As an example, the first blocking surface 643 may be a predetermined distance from the outlet of the nozzle portion 640 as one side forming the first mixing space 642. In this example, the end of the first blocking surface 643 may be located at a height corresponding to 90% to 110% of the distance from the side of the first mixing space 642 to the extension line of the centerline C of the decomposition unit 624. In the embodiment, shown is an example in which the end of the first blocking surface 643 is located at a height corresponding to the extension line of the center line C of the decomposition unit 624. As such, by forming the first blocking surface 643, it is possible to simplify the configuration of the nozzle portion 640 while blocking the direct injection and discharge of the wash water from the decomposition unit 624 and maximizing the size of the flow path through which the wash water is supplied.

The wash water will slow down in the first mixing space 642, where the flow path is widened from the narrower decomposition unit 624. The first blocking surface 643 may prevent the wash water with slow flow from discharging by direct injection from the decomposition unit 624 to the second mixing space 644. Therefore, the wash water, which is slowed and temporarily retained in the first mixing space 642 by the first blocking surface 643, may collide with the wash water injected from the dissolving unit 624 to strike the first blocking surface 643 and then into the first mixing space 642, thereby generating additional micro-bubbles. The first blocking surface 643 may be formed at an angle to prevent the direct injection of the wash water discharged from the decomposition unit 624. By preventing the direct injection, it is possible to allow the micro-bubbles generated in the decomposition unit 624 to spread evenly into the wash water and/or to prevent the micro-bubbles from being discharged immediately without being dissolved or suspended in the wash water for a sufficient time. Also, it is possible to generate additional micro-bubbles in the first mixing space 642.

In summary, according to the nozzle unit 600 of an embodiment of the disclosure, when the bubbles introduced from the dissolving unit 500 pass through the expanding decomposition unit 624, the pressure is increased and the flow slows down at the same time. Accordingly, the bubbles may then be split into micro-bubbles, and additional (micro)bubbles may be generated. The slow-flow micro-bubbles passing through the decomposition unit 624 may be discharged to the first mixing space 642. In this case, a portion of the micro-bubbles may be relatively slowly discharged from the first mixing space 642 to the second mixing space 644, and another portion of the micro-bubbles may collide with the first blocking surface 643 to prevent the direct injection. The micro-bubbles colliding with the first blocking surface 643 may not be directly injected into the second mixing space 644, but may be injected into the first mixing space 642, so that a collision may occur between the bubbles in the first mixing space 642, and then the bubbles may be split into micro-bubbles, and the amount of bubbles may increase. Thus, since the micro-bubbles may collide with the first blocking surface 643 so as not to be fed directly into the second mixing space 644 by direct injection, and additional micro-bubbles may be generated by the first blocking surface 643, the amount of micro-bubbles may increase.

The micro-bubbles in the first mixing space 642 are discharged to the second mixing space 644. The second mixing space 644 may serve as a guide to direct the micro-bubbles to a discharging position where they are discharged into the inner basket 22. The second blocking surface 645 may be at a portion of the second mixing space 644 near or approaching the discharging position. The micro-bubbles discharged from the first mixing space 642 collide with the second blocking surface 645, and the direct injection may be prevented once more. The bubbles discharged in the bubble state from the first mixing space 642 may collide with the second blocking surface 645 and may be split into micro-bubbles, which may increase the amount of micro-bubble generation. In addition, since the second blocking surface 645 may be near the discharging position, the micro-bubbles discharged from the second blocking surface 645 may be supplied directly into the inner basket 22. In addition, the nozzle portion 640 may further include a discharging portion 646, a body connection unit 648, and a nozzle fixing unit 649.

The wash water containing the micro-bubbles may be discharged to the washing space through the discharging portion 646. The discharging portion 646 may have a wider cross-section toward the discharging port. The inner surface of the discharging portion 646 may include the second blocking surface 645. In addition, the discharging portion 646 may be inclined at a predetermined angle in the direction of the inner basket 22 from the second mixing space 644. The second blocking surface 645 may be inclined at a predetermined angle in the direction of the inner basket 22 so as to correspond to the discharging portion 646. Since the discharging portion 646 is inclined and open or directed toward the inner basket 22, it may prevent scattering of the micro-bubbles discharged to the inner basket 22.

The body connection unit 648 may include a surface extending from one end of the nozzle portion 640 in the vertical direction of the flow path of the nozzle unit 600 and may include holes at a position corresponding to the nozzle connection unit 618 of the body portion 610 on the extended surface. Fastening members may pass through or be inserted into the holes. Thus, the body connection unit 648 is brought into contact with the nozzle connection unit 618 of the body portion 610, and the fastening members such as bolts may be inserted or passed through the holes into the nozzle portion connection unit(s) 618 to fasten the body portion 610 and the nozzle portion 640.

In addition, the lower portion of the body connection unit 648 may have a shape extending in the direction of the body portion 610 from the upper portion so that the nozzle portion 640 supports the bubble generating portion 620 more stably (e.g., than the lower portion). For example, the lower portion of the body connection unit 648 may substantially or entirely cover the bubble generating portion 620, and the upper portion of the body connection unit 648 may have a predetermined length exposing part or all of the bubble generating portion 620. Accordingly, nozzle portion connection units 618 on the upper portion may extend toward the nozzle portion 640, and nozzle portion connection units 618 on the lower portion may extend toward the dissolving unit connection unit 612.

The nozzle fixing unit 649 may be on opposite sides of the body connection unit 648 in a direction perpendicular to the body connection unit 648. That is, the nozzle fixing unit 649 may be parallel to the flow path of the nozzle unit 600. Holes may be in the nozzle unit fixing unit 649 so that fastening members may be inserted therethrough. Thus, the nozzle unit 600 may be secured to the cabinet cover 14.

The flowing principle of the wash water flowed by the nozzle unit 600 according to one embodiment of the disclosure is summarized as follows: the wash water introduced through the dissolving unit connection unit 612 may be introduced into the pressing space 615 and be pressurized while staying there for a predetermined time. Thereafter, bubbles in the wash water in the pressing space 615 may be split into micro-bubbles in the wash water or may generate other micro-bubbles as they pass through the decomposition unit 624. The wash water discharged from the decomposition unit 624 into the first mixing space 642 is at least partially redirected by the first blocking surface 643 into the first mixing space 642 and stays in the first mixing space 642 for a certain period of time after colliding against the first blocking surface 643. Accordingly, additional micro-bubbles may be generated, and the micro-bubbles may be evenly distributed within the wash water. In addition, the wash water containing micro-bubbles passing through the first mixing space 642 may again collide with the second blocking surface 645 of the second mixing space 644 to increase the micro-bubble generation, while preventing further direct injection of the micro-bubbles. Therefore, it is possible to improve the washing abilities and rinsing abilities of the wash water and washing machine by increasing the micro-bubble production.

Referring to FIGS. 7 to 9, the cabinet cover 14 may include a plate 140, an input hole 141, a detergent container accommodating portion 142, a nozzle installation groove 144, and a nozzle coupling unit 146.

The center of the plate 140 may have an input hole 141 to allow the laundry to be introduced into the inner basket 22 in a size and/or amount corresponding to the diameter and/or size of the inner basket 22. The user may input the laundry through the input hole 141.

The detergent container containment portion 142 may be at one point around the input hole 141 of the plate 140. The detergent container receiving portion 142 may correspond to the size and shape of the detergent container 30, such that the detergent container 30 may slidably open and close.

The nozzle installation groove 144 may enable the nozzle unit 600 to be installed at another point around the input hole 141 of the cabinet cover 14.

The nozzle coupling unit 146 may be on the bottom surface of the outer side of the input hole 141 of the cabinet cover 14 so that the nozzle unit 600 may be coupled to the cabinet cover 14. The nozzle coupling unit 146 may have a cavity into which bolts 670 to be described later may be inserted.

Also, the washing machine 1 according to one embodiment of the disclosure may further include a nozzle cover 650 to cover the nozzle unit 600.

The nozzle cover 650 may cover a portion of the nozzle unit 600 in the cabinet cover 14 to prevent the nozzle unit 600 from being contacted by the laundry that is introduced into the input hole 141. In addition, the nozzle cover 650 may protect the nozzle unit 600 and provide the user with aesthetic feel as a portion exposed to the user. The nozzle cover 650 may include a shield unit 652, nozzle cover fixing units 654, coupling holes 655, and a connection unit 656.

The shield unit 652 may shield a portion of the nozzle unit. The shield unit 652 is a cover portion that covers the second blocking surface 645 and the discharging portion 646 of the nozzle portion 640 and may be exposed to the user. The shield unit 652 may protect the discharging portion 646, and may add aesthetics for the user. The shield unit 652 may correspond to the nozzle installation groove 144 in the plate 140 so that a gap may not arise when the shield unit 652 is in the nozzle installation groove 144. Therefore, the inner structure of the plate 140 may not be exposed to the user, and foreign matter may be prevented from entering through the plate 140.

The nozzle cover fixing unit 654 may be connected to the shield unit 652 by a connection unit 656, and the nozzle cover fixing unit 654 may be fixed to the nozzle coupling unit 146 together with the nozzle unit 600 at the bottom of the plate 140. The nozzle cover fixing unit 654 may include the coupling holes 655 for insertion into the nozzle coupling unit 146.

The washing machine 1 according to one embodiment of the disclosure may further include bolts 670 for fixing the nozzle unit 600 to the nozzle coupling unit 146 and vibration-proof rubber gaskets or rings 660 fitting around the bolts 670 to absorb vibrations in the nozzle unit 600.

Each vibration-proof rubber gasket or ring 660 may include a nozzle portion fitting groove 662, a damping unit 664, and a bolt head supporting unit 666.

The nozzle portion fitting groove 662 may be at one end in the bottom surface direction of the cabinet cover 14 of the vibration-proof rubber gasket or ring 660 so that a portion of the nozzle unit 600 may be fitted with the rubber gasket or ring 660. Specifically, the nozzle portion fitting groove 662 may be around the outer circumferential surface of the vibration-proof rubber gasket or ring 660. The nozzle fixing unit 649 is fitted to the nozzle portion fitting groove 662 so that the nozzle unit 600 may be fixed. Thus, the nozzle portion fitting groove 662 may correspond to the size and shape of the hole formed in the nozzle fixing unit 649.

The damping unit 664 may be between the nozzle portion fitting groove 662 at one end of the rubber gasket or ring 660 and the bolt head supporting unit 666 at the other end of the rubber gasket or ring 660, and may be elastically deformable (e.g., bent in a jar shape). The damping unit 664 may be elastically deformed in the longitudinal direction of the vibration proof rubber gasket or ring 660 (that is, in the direction of the bolt head supporting unit 666 from the nozzle portion fitting groove 662), such that the vibrations from the washing machine 1 and vibrations, trembling and the like from the nozzle unit 600 of the micro-bubble generator BG may be absorbed.

The bolt head supporting unit 666 may be at the other end of the vibration proof rubber gasket or ring 660 to support the head of the bolt 670. The bolt head supporting unit 666 may be supported in contact with one side of the bolt head 670.

The bolt 670 may include a bolt head 672 and an insert 674. The bolt 670 may be inserted through the bolt head supporting unit 666 of the vibration-proof rubber gasket or ring 660 toward the nozzle portion fitting groove 662. Accordingly, when the bolt 670 is inserted, the bolt head 672 may contact and be supported by the bolt head supporting unit 666. The gasket or ring insertion portion 674 may be at an intermediate portion of the bolt 670 and may be a portion covered by the vibration proof rubber gasket or ring 660.

The bolt 670 may be fixed to the nozzle coupling unit 146 by passing through the vibration-proof rubber gasket or ring 660, the nozzle unit 600 and the nozzle cover 650 sequentially. Specifically, the bolt 670 may be inserted and fixed into the cavity in the nozzle coupling unit 146 after passing through the insertion hole in the center of the vibration-proof rubber gasket or ring 660, the nozzle fixing unit 649 of the nozzle unit 600, the nozzle cover fixing unit 654, and the coupling hole 655 in the nozzle cover fixing unit 654 of the nozzle cover 650, sequentially.

Thus, the nozzle unit 600 may be in the input hole 141 of the cabinet cover 14 and positioned above the inner basket 22. Accordingly, the micro-bubbles in the dissolving unit 500 and the nozzle unit 600 may be supplied into the inner basket 22 without being extinguished.

The drain unit 700 may discharge the wash water remaining in the dissolving unit 500 to the main drain hose 34 after completing the supply of the wash water containing the micro-bubbles to the inner basket 22.

The drain unit 700 may be below the dissolving unit 500 and may discharge the wash water from the dissolving unit 500 onto a location corresponding to a slipstream of the main drain valve 36 of the main drain hose 34. Accordingly, the drainage from the drain unit 700 may be achieved, regardless of the operation of the main drain valve 36.

Here, referring to FIGS. 2, 10 and 11, the drain unit 700 may include a first body 710, a second body 720, a diaphragm 730, a diaphragm supporting unit 740, and a gasket 750.

Specifically, the drain unit 700 may include a first body 710 connected to the dissolving unit 500 to receive wash water, and a second body 720 coupled to the first body 710 and connected to the main drain hose 34 to discharge the wash water.

Besides the first body 710 and the second body 720 as described above, the drain unit 700 may include an elastically deformable diaphragm 730 between the first body 710 and the second body 720 that has a first hole 736 through which the wash water may pass, and a diaphragm supporting unit 740 having a second hole 748 between the first body 710 and the second body 720 and selectively shielded by elastic deformation of the diaphragm 730.

One or more female threads (or a groove) and one or more male threads may be on or in the first body 710 and the second body 720 so that they may be screwed together. However, the method of coupling the first body 710 and the second body 720 is not limited to screw coupling, and various fastening methods such as a form coupling and a bolt coupling may be applied. The first body 710 may include a dissolving unit connection unit 712 connected to the dissolving unit 500. The dissolving unit connection unit 712 may extend away from the second body 720, and the dissolving unit connection unit 712 may be connected to the first drain line L3, such that the wash water remaining in the washing container 500 may be drained.

The second body 720 may include a main drain hose connection unit 722 connected to the main drain hose 34 and a diaphragm accommodating portion 726. The main drain hose connection unit 722 may extend away from the first body 710. The main drain hose connection unit 722 may be connected to the second drain line L4 to drain the wash water.

The center of the inlet and outlet of the dissolving unit connection unit 712 and the inlet and outlet of the main drain hose connection unit 722 may be linear or along the same straight line. Thus, the wash water that drains through the dissolving unit connection unit 712 may be smoothly drained to the main drain hose connection unit 722.

The diaphragm accommodating portion 726 is a cavity in the second body 720 and may accommodate a diaphragm 730 and a diaphragm supporting unit 740. Accordingly, the diaphragm accommodating portion 726 may have one or more diameters corresponding to the diameters of the diaphragm 730 and the diaphragm supporting unit 740, so that the diaphragm 730 and the diaphragm supporting unit 740 may be stably inserted or placed therein.

The first hole 736 in the diaphragm 730 and the second hole 748 in the diaphragm supporting unit 740 may be or comprise passages through which the wash water passes for drainage. The diaphragm 730 and the diaphragm supporting unit 740 may drain the wash water when separated from each other or block the drainage of the wash water when in contact with each other by hydraulic pressure. Specifically, the diaphragm 730 may elastically deform to block the second hole 748 of the diaphragm supporting unit 740 when the water supply pressure of the wash water is greater than a predetermined value, and return to the original (undeformed) state when the water supply pressure is less than the predetermined value to open the second hole 748 (here, the predetermined value may be the value or a minimum value of the pressure according to the load of the wash water supplied from the water supply valve unit 32 to the dissolving unit 500).

First, the diaphragm 730 may include an elastic deformation part 732, a hanging groove 733, a shield unit 734, a fixing unit 735, and a first hole 736.

The elastic deformation part 732 is elastically deformed by the pressure of the wash water and then may return to its original state, and it may have a U-shaped cross-section extending toward the dissolving unit connection unit 712 along the periphery of the shield unit 734. In addition, the elastic deformation part 732 may connect the fixing unit 735 and the shield unit 734.

At least one first hole 736 may be in the shield unit 734. Specifically, a plurality of first holes 736 may be along the periphery of the shield unit 734, and the second hole 748 may be shielded by a central portion of the shield unit 734 between or inside the plurality of first holes 736. To shield the second hole 748, the shield unit 734 may be larger (e.g., the central portion may have a larger diameter) than the diameter of the second hole 748.

The shield unit 734 may shield the second hole 748 of the diaphragm supporting unit 740 by the pressure of the wash water provided to the drain unit 700. In detail, if wash water having a certain level of pressure or more with respect to the drain unit 700 (for example, if the wash water supplied to the dissolving unit 500 by the water supply valve unit 32 moves to the drain unit 700), the elastic deformation part 732 may be deformed, and thus, the shield unit 734 may move toward the diaphragm supporting unit 740. Accordingly, the shield unit 734 and the diaphragm supporting unit 740 may then be in contact with each other, and the second hole 748 may be shielded. Conversely, when no pressure is applied to the drain unit 700 (specifically, when the wash water is not supplied from the water supply valve unit 32), the elastic deformation part 732 may return the shield unit 734 to its original position, and thus, the second hole 748 may be opened.

The fixing unit 735 may be along the periphery of the shield unit 734 and may be secured to the diaphragm supporting unit 740. The fixing unit 735 may extend from the elastic deformation part 732 towards the diaphragm supporting unit 740 and may be supported by and/or in contact with a mounting unit 742 of the diaphragm supporting unit 740. In this regard, a groove 733 may be in the fixing unit 735 so that a lip or bead 746 in the diaphragm supporting unit 740 may be inserted therein, and thus the diaphragm 730 and the diaphragm supporting unit 740 may be stably fixed to each other.

The diaphragm supporting unit 740 may include a second hole 748 through which the wash water drains, support ribs 744 tightly fixed to the inner side or surface of the second body 720 so as not to bend, and a mounting unit 742 connected to the support ribs 744 and to which the diaphragm 730 may be seated and/or secured.

The mounting unit 742 may be in contact with the connection unit of the diaphragm 730 to seat the diaphragm 730, and the support ribs 744 may support the diaphragm 730 in contact with the mounting unit 742.

In addition, the mounting unit 742 may include a lip or bead 746 to allow the diaphragm 730 and the diaphragm supporting unit 740 to be secured to each other. The lip or bead 746 may be inserted into the groove 733 of the diaphragm 730.

Here, the first hole 736 and the second hole 748 of the diaphragm 730 and the diaphragm supporting unit 740 may be offset from each other. This allows the second hole 748 to be opened or closed depending on the elasticity of the elastic deformation part 732.

In addition, the drain unit 700 may include a gasket 750 adjacent to the dissolving unit connection unit 712 in the space in the first body 710 that is pressed by the end of the second body 720. The gasket 750 may be or comprise an O-ring and around the end of the dissolving unit connection unit 712 in the first body 710 to prevent the wash water from leaking.

In the drain unit 700 having the configuration as described above, when the wash water is supplied from the water supply valve unit 32 to the dissolving unit 500, the wash water in the dissolving unit 500 may move to the drain unit 700 and pressurize the diaphragm 730 (herein, the predetermined pressure may be a pressure dependent on a load of the wash water remaining in the dissolving unit 500 if there is no wash water supply from the water supply valve unit 32 to the dissolving unit 500). Accordingly, when the wash water is introduced from the dissolving unit 500 into the drain unit 700 at a pressure greater than the predetermined pressure, the diaphragm 730 in the drain unit 700 may elastically deform to block the second hole 748 through which the wash water is discharged. Thereby, the dissolving unit 500 may be filled with the wash water, and the wash water in which the gas is dissolved or mixed may be supplied to the nozzle unit 600.

Meanwhile, if the wash water is not supplied from the water supply valve unit 32, the elastic deformation part 732 returns the shield unit 734 to its original position, thereby opening the second hole 748 to drain the wash water.

Therefore, the drain unit 700 according to the present embodiment may operate reliably while reducing the manufacturing cost and providing the micro-bubble generator with a simple structure.

Hereinafter, the operation and effect of the washing machine 1 and the micro-bubble generator BG, and a method of supplying wash water including micro-bubbles according to one embodiment of the disclosure, will be described.

First, the wash water may be supplied from an external water supply source via a water supply valve unit 32. Next, the gas may be dissolved or mixed in the wash water supplied from the dissolving unit 500.

Herein, in order to dissolve or mix the gas in the wash water in the dissolving unit 500, the wash water may be supplied through the water supply line connection unit 532 in the horizontal direction of the cap 530 from the water supply valve unit 32 above the dissolving unit 500, and the horizontal flow direction of the wash water in the cap 530 may change to the vertical direction by the water supply direction switching portion 534 of the cap 530. The wash water may be relatively uniformly discharged by the water supply direction switching portion 534, and may fill the inner tube 520 and then overflow. The wash water overflowing from the inner tube 520 may enter the space between the inner tube 520 and the outer tube 510 to allow the gas to dissolve or mix in the wash water.

In other words, the drain unit 700 elastically deforms from the pressure of the wash water supplied from the water supply valve unit 32 to the dissolving unit 500, and then the second hole 748 in the diaphragm supporting unit 740 may be blocked. Accordingly, the wash water supplied from the water supply valve unit 32 may be mixed with the gas in the dissolution space of the dissolving unit 500.

By this process, the wash water in which the gas is dissolved or mixed is supplied from the dissolving unit 500 to the nozzle unit 600, and the nozzle unit 600 may form micro-bubbles by splitting the bubbles in the wash water.

The bubbles formed by dissolving or mixing the gas in the wash water in the dissolving unit 500 may flow into the pressing space 615 in the body portion 610 of the nozzle unit 600 and may be pressurized. The flow rate may increase when entering the inlet 624a of the small diameter decomposition unit 624, whose diameter is smaller than the pressing space 615. Subsequently, the bubbles in the water with the increased flow rate pass through the outlet 624b extending from the inlet 624a. Since the flow slows down and the pressure increases while passing through the decomposition unit 624, the bubbles may be split into micro-bubbles. A portion of the micro-bubbles discharged from the decomposition unit 624 may be injected into the first mixing space 642 without being directly injected by contacting the first blocking surface 643 in the nozzle portion 640, and the amount of micro-bubble generation may increase during the collision between the bubbles. The wash water discharged from the first mixing space 642 may pass through the second mixing space 644, may be prevented again from being directly injected by the second blocking surface 645, and may then be discharged through a discharging portion 646, during which the amount of micro-bubble generation may increase. In the course of the above processes, the discharged micro-bubbles may flow into the inner basket 22 by the aid of the inner surface of the discharging portion 646 and/or the second blocking surface 645. Thus, the nozzle unit 600 may discharge the wash water containing the micro-bubbles into the inner basket 22 where the laundry is accommodated.

Meanwhile, when the delivery of the wash water containing the micro-bubbles into the inner basket 22 is completed, the wash water remaining in the dissolving unit 500 may be drained to the main drain hose 34 by the drain unit 700. Specifically, if the wash water is introduced from the dissolving unit 500 into the drain unit 700 at a pressure less than a predetermined pressure (that is, a pressure less than the pressure of the water supplied from the water supply valve unit 32), since the wash water in the unit 500 does not apply a load to the diaphragm 730, the elastic deformation part 732 of the diaphragm 730 may be restored to its original state, and the drainage may be achieved by opening the second hole 748.

As set forth above, according to the embodiments of the disclosure, a washing machine, a micro-bubble generator for the washing machine, and a method for supplying wash water including micro-bubbles in the washing machine have advantages of increasing the washing and rinsing abilities of the washing machine by increasing the amount of micro-bubble production.

As described above, while the present disclosure has been described in connection with a washing machine, a micro-bubble generator for the washing machine, and a method of supplying wash water having micro-bubbles in the washing machine, it is merely an example and the present disclosure is not limited thereto. It should be understood that the present disclosure has the widest range in compliance with the basic idea disclosed in the disclosure. Although it is possible for those skilled in the art to combine and substitute the disclosed embodiments to embody other types that are not specifically disclosed in the disclosure, they do not depart from the scope of the present disclosure as well. In addition, it will be apparent to those skilled in the art that various modifications and changes may be made with respect to the disclosed embodiments based on the disclosure, and these changes and modifications also fall within the scope of the present disclosure.

What is claimed is:

1. A washing machine, comprising:
a cabinet;
an outer basket in the cabinet and configured to contain wash water;
an inner basket in the outer basket and configured to accommodate laundry;
a water supply valve unit in the cabinet and connected to an external water supply source to receive wash water; and
a micro-bubble generator configured to receive wash water from the water supply valve unit, generate micro-bubbles, and supply the micro-bubbles to a washing space, wherein the micro-bubble generator includes a dissolving unit configured to dissolve or mix gas in the wash water from the water supply valve unit, and the dissolving unit includes:
an outer tube having (i) an opening at one side or end and (ii) a dissolution space in which the gas is dissolved or mixed in the wash water;
an inner tube in the dissolution space, at least a part of the inner tube being spaced from an inner circumferential surface of the outer tube; and
a cap configured to cover or shield the opening of the outer tube, and change a direction of the wash water, and supply the wash water to the inner tube, and
the gas in the outer tube dissolves or mixes in the wash water by pressure of the wash water overflowing from the inner tube.

2. The washing machine according to claim 1, wherein the micro-bubble generator further includes:
a nozzle unit configured to receive the wash water in which the gas is dissolved or mixed from the dissolving unit and generate the micro-bubbles; and
a drain unit configured to discharge the wash water remaining in the dissolving unit.

3. The washing machine according to claim 2, further comprising:
a cabinet cover on an upper side of the cabinet and having an input hole for inputting laundry,
wherein the nozzle unit is at or near the input hole and is configured to discharge wash water with the micro-bubbles therein into the inner basket.

4. The washing machine according to claim 2, wherein the dissolving unit is configured to generate bubbles from the gas in the wash water, and the nozzle unit is configured to split the bubbles into the micro-bubbles.

5. The washing machine according to claim 1, wherein the dissolving unit is oriented in a longitudinal direction, the water supply valve unit is on an upper side of the dissolving unit; and the wash water from the water supply valve unit enters the cap in a horizontal direction and is discharged in a vertical direction to the inner tube.

6. The washing machine according to claim 1, wherein the dissolving unit is fixed to an inner side wall of the cabinet and spaced apart from the outer basket, and
the outer tub has a supply line fixing unit at one side thereof, configured to fix a supply valve for guiding the wash water containing dissolved or mixed gas therein to a discharging position.

7. The washing machine according to claim 1, wherein the washing space is inside the outer basket, the cap changes the direction of the wash water by a predetermined angle, and the drain unit is configured to discharge the wash water remaining in the dissolving unit after the micro-bubbles are generated.

8. The washing machine according to claim 3, wherein the nozzle unit is configured to discharge the wash water with the micro-bubbles therein after the micro-bubbles are generated.

9. A micro-bubble generator, comprising:
a dissolving unit configured to receive wash water and to dissolve or mix gas in the wash water;
a nozzle unit configured to receive the wash water in which gas is dissolved or mixed from the dissolving unit, generate the micro-bubbles, and discharge the wash water containing the micro-bubbles; and
a drain unit configured to discharge the wash water remaining in the dissolving unit after the wash water containing the micro-bubbles is discharged,
wherein the dissolving unit includes:
an outer tube having an open cylindrical shape to accommodate the gas and the wash water;
an inner tube in the outer tube and having a side surface and a lower end spaced apart from an inner side surface of the outer tube, the inner tube having an open upper end configured to overflow the wash water; and
a cap having a water supply line connection unit coupled to an upper end of the outer tube, the cap being configured to cover or shield the outer tube and having a water supply direction switching portion configured to change a direction of the wash water from the water supply line connection unit to the inner tube.

10. The micro-bubble generator according to claim 9, wherein the outer tube further includes:
a nozzle cover fixing unit configured to supply the wash water in which the gas is dissolved or mixed to the nozzle unit; and
a drain unit connection unit configured to connect the outer tube to the drain unit,
wherein the nozzle cover fixing unit and the drain unit connection unit are oriented in a different direction from each other.

11. The micro-bubble generator according to claim 9, wherein the inner tube has a residual water discharge hole at its lower end that discharges the wash water in the inner tube,
the residual water discharge hole has a diameter smaller than that of the open upper end of the inner tube, and
the residual water discharge hole is directly above the drain unit connection unit.

12. The micro-bubble generator according to claim 9, wherein the inner tube has an overflow portion which includes a plurality of overflow holes at the open upper end of the inner tube along a circumference of the inner tube so that the wash water in the inner tube can overflow, and
an upper end of the overflow portion is on an upper end of the outer tube.

13. The micro-bubble generator according to claim 9, wherein the inner tube has a volume that is less than one-third of a volume of the outer tube.

14. The micro-bubble generator according to claim 13, wherein the inner tube has a lower end that is higher than a location one-third of a total length of the outer tube from a lowermost end of the outer tube.

15. The micro-bubble generator according to claim 9, wherein the water supply line connection unit extends horizontally from the cap to allow wash water to be introduced horizontally into the cap, and
a water supply line connected to the water supply line connection unit is configured to change a flow direction of the wash water at least once.

16. The micro-bubble generator according to claim 15, further comprising a water supply direction switching portion comprising a vertically-oriented space and configured to communicate with a discharging side or end of the water supply line connection unit, the water supply direction switching portion being at a position corresponding to a center of the inner tube, and
the water supply line connection unit is configured to introduce the wash water into the inner tube by switching a direction of the wash water using the water supply direction switching portion.

17. The micro-bubble generator according to claim 9, wherein the cap further includes:
an air pocket portion on an opposite side from the water supply line connection unit with respect to the water supply direction switching portion, the air pocket portion communicating with the dissolving unit and having a space configured to accommodate the gas.

18. The micro-bubble generator according to claim 9, further comprising:
a water supply line configured to supply the wash water to the dissolving unit;
a supply line configured to provide the wash water in which the gas is dissolved or mixed from the dissolving unit to the nozzle unit;
a first drain line configured to drain residual wash water from the dissolving unit to the drain unit; and
a second drain line configured to drain the residual wash water from the drain unit to the main drain hose.

19. A method for supplying wash water including micro-bubbles in a washing machine, the method comprising:
receiving wash water from an external water supply source in a water supply valve unit;
dissolving or mixing gas in the wash water in a dissolving unit;
receiving, at a nozzle unit, the wash water in which the gas is dissolved or mixed from the dissolving unit;
forming the micro-bubbles by splitting bubbles in the wash water containing dissolved or mixed gas therein;
discharging, at a nozzle unit, the wash water containing the micro-bubbles into an inner tube containing the wash water; and
draining the wash water remaining in the dissolving unit into a drain unit after discharging the wash water containing the micro-bubbles,
wherein the dissolving unit includes:
an outer tube;
an inner tube in the outer tube and spaced apart from an inner circumferential surface of the outer tube; and
a cap configured to cover or shield an upper end of the outer tube, and wherein dissolving or mixing the gas comprises:
supplying the wash water along a water supply line in a vertical direction from the water supply valve unit above the dissolving unit;
changing a direction of the wash water inside the cap;
filling the inner tube with the wash water.
allowing the wash water to overflow after the inner tube is filled with the wash water;
introducing the wash water overflowing from the inner tube into a space between the inner tube and the outer tube to allow gas to dissolve or mix in the wash water.
